(19) United States
(12) Patent Application Publication
(10) Pub. No.: US 2007/0143174 A1
(43) Pub. Date: Jun. 21, 2007

(54) Repeated inheritance of heterogeneous business metrics

(75) Inventors: Ian Tien, Seattle, WA (US); Chen-I Lim, Bellevue, WA (US); Corey Hulen, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/313,327

(22) Filed: Dec. 21, 2005

(51) Int. Cl. G06F 11/34

(52) U.S. Cl. 705/11

(57) ABSTRACT

An approach and a data structure for inheriting reporting metrics in a business logic system are provided. A scorecard structure includes a top level metric (scorecard) that receives aggregated scores from hierarchically structured lower level measures such as KPI's and objectives. Each KPI may be assigned target values and each target a status indicator. Upon selecting elements of the scorecard such as measures, targets, data sources, and the like, data associated with the elements including content and property information is retrieved. Elements are ordered according to the scorecard hierarchy and scored based on the order.

### BACKGROUND

Key Performance Indicators, also known as KPI or Key Success Indicators (KSI), help an organization define and measure progress toward organizational goals. Once an organization has analyzed its mission, identified all its stakeholders, and defined its goals, it needs a way to measure progress toward those goals. Key Performance Indicators are used to provide those measurements.

Scorecards are used to provide detailed and summary analysis of KPI's and aggregated KPI's such as KPI groups, objectives, and the like. Scorecard calculations are typically specific to a defined hierarchy of the above mentioned elements, selected targets, and status indicator schemes. Thus, setting up a new scorecard with modified settings is complicated even if similar reporting measures are used.

### SUMMARY

A data structure is used in an approach for inheriting reporting metrics in a business logic system. The approach is directed at enabling use of reporting metrics with heterogeneous schemas. A scorecard structure includes a top level metric that receives aggregated scores from hierarchically structured lower level measures. Each lower level measure may be assigned target values and each target a status indicator. Upon selecting elements of the scorecard, such as: measures, targets, data sources, and the like, data associated with the elements is retrieved. Elements are ordered according to the scorecard hierarchy and scored based on the order enabling reuse and customization of the scorecard.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a business logic application may be executed using repeated inheritance of heterogeneous business metrics;

FIG. 2 illustrates a system, where example embodiments of repeated inheritance of heterogeneous business metrics may be implemented;

FIG. 3 illustrates an example scorecard architecture according to embodiments;

FIG. 4 illustrates a screenshot of an example scorecard;

FIG. 5 illustrates boundary selection in a scorecard application using text boxes and sliders, and relationship of boundary sliders with indicator ranges in boundary preview;

FIGS. 6A and 6B illustrate example scorecard structures;

FIG. 7 illustrates a screenshot of a scorecard application user interface;

FIG. 8 illustrates a screenshot of a scorecard view editor user interface; and

FIG. 9 illustrates a logic flow diagram for a process of repeated inheritance of heterogeneous business metrics.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

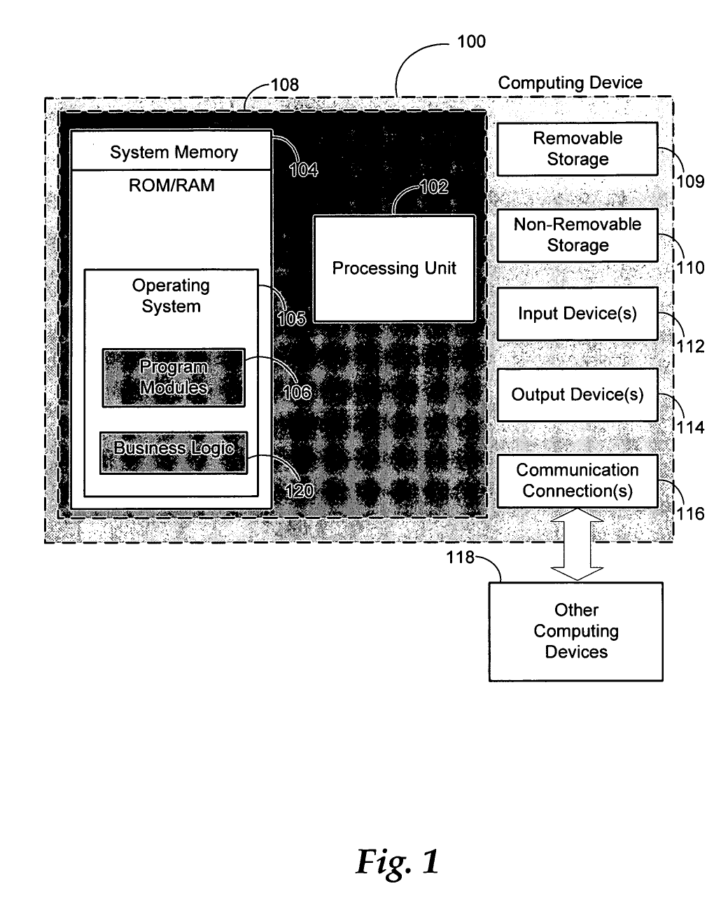

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105 and one or more program modules 106 working within operating system 105.

In addition to program modules 106, business logic application 120 may also be executed within operating system 105. Business logic application 120 may include a scorecard application or any similar application to manage business evaluation methods. Business logic application 120 may provide scoring services for new scorecards based on selection and ordering of elements from existing scorecards.

To perform the actions described above, business logic application 120 may include and/or interact with other computing devices, applications, and application interfaces (APIs) residing in other applications.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

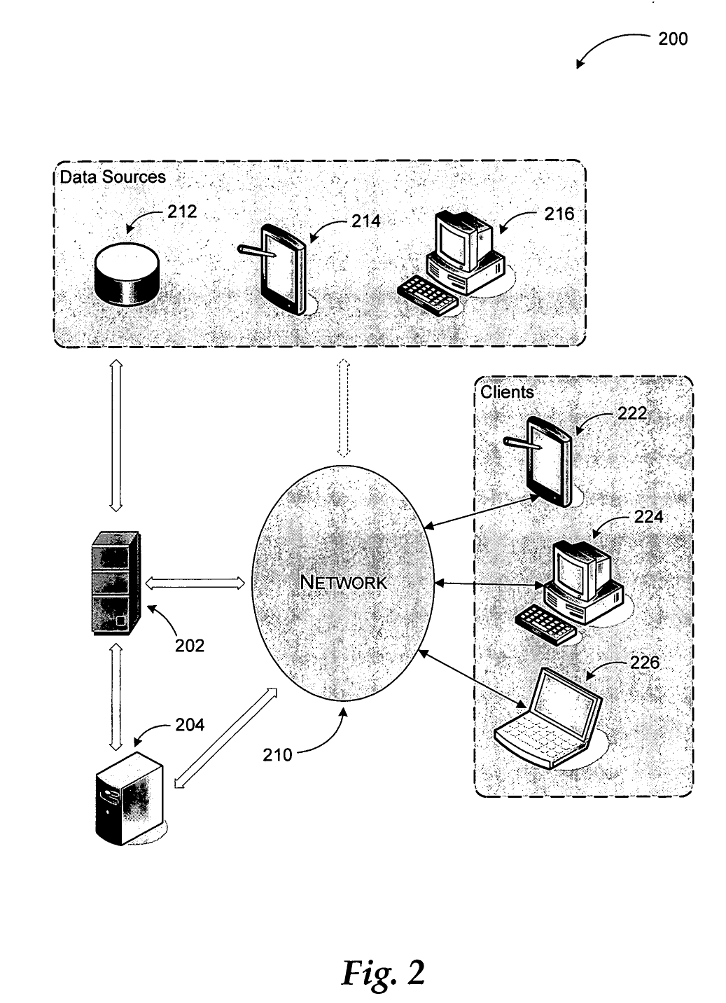

FIG. 2 illustrates system 200, where example embodiments of repeated inheritance of heterogeneous business metrics may be implemented. System 200 may comprise any topology of servers, clients, Internet service providers, and communication media. Also, system 200 may have a static or dynamic topology.

A business logic application may be run centrally on server 202 or in a distributed manner over several servers (e.g. servers 202 and 204) and/or client devices. Server 202 may include implementation of a number of information systems such as performance measures, business scorecards, and exception reporting. A number of organization-specific applications including, but not limited to, financial reporting, analysis, booking, marketing analysis, customer service, and manufacturing planning applications may also be configured, deployed, and shared in system 200. In addition, the business logic application may also be run in one or more client devices and information exchanged over network 210.

Data sources 212, 214, and 216 are examples of a number of data sources that may provide input to server 202. Additional data sources may include SQL servers, databases, non multi-dimensional data sources such as text files or EXCEL® sheets, multi-dimensional data source such as data cubes, and the like.

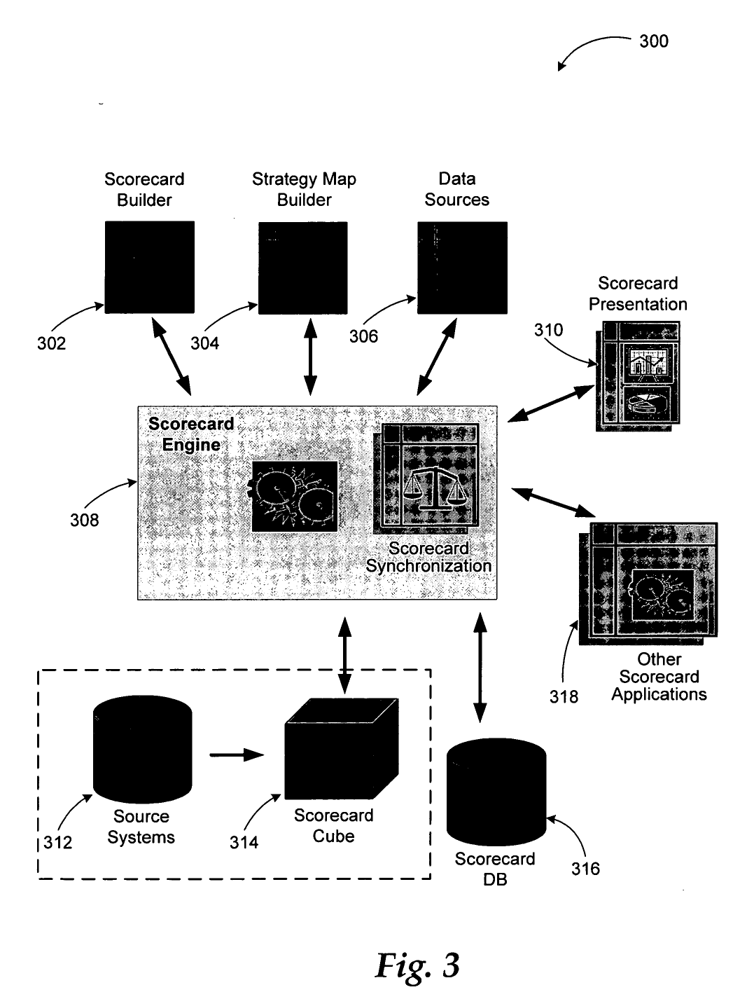

Users may interact with server 202 running the business logic application from client devices 222, 224, and 226 over network 210. The business logic application may inherit reporting metrics and score them according to their order enabling the users to reuse and customize scorecards. In one embodiment, additional applications that consume scorecard-based data may reside on server 202 or client devices 222, 224, and 226. Examples of such applications and their relation to the scorecard application are provided below in conjunction with FIG. 3.

Network 210 may be a secure network such as an enterprise network, or an unsecure network such as a wireless open network. Network 210 provides communication between the nodes described above. By way of example, and not limitation, network 210 may include wired media such as a wired network or direct-wired connection, and wireless media such as acoustic, RF, infrared and other wireless media.

Many other configurations of computing devices, applications, data sources, data distribution and analysis systems may be employed to implement a business logic application centrally managing updates to scorecard-based reports.

FIG. 3 illustrates example scorecard architecture 300. Scorecard architecture 300 may comprise any topology of processing systems, storage systems, source systems, and configuration systems. Scorecard architecture 300 may also have a static or dynamic topology.

Scorecards are a simple method of evaluating organizational performance. The performance measures may vary from financial data such as sales growth to service information such as customer complaints. In a non-business environment, student performances and teacher assessments may be another example of performance measures that can employ scorecards for evaluating organizational performance. In the exemplary scorecard architecture (300), a core of the system is scorecard engine 308. Scorecard engine 308 may be an application that is arranged to evaluate performance metrics. Scorecard engine 308 may be loaded into a server, executed over a distributed network, executed in a client device, and the like.

According to one embodiment, a data structure for inheriting reporting metrics in a business logic system may include a first metric stored in a first region of a range of memory addresses in the medium, and second metrics that are stored in a second region of the range of memory addresses in the medium, where a portion of the second metrics report to the first metric based on a predetermined roll-up relationship. The data structure may further include third metrics stored in a third region of the range of memory addresses in the medium, where a portion of the third metrics report to one of the second metrics based on the predetermined roll-up relationship, and another portion of the third metrics report to the first metric based on the predetermined roll-up relationship. The data structure may also include target values stored in a fourth region of the range of memory addresses in the medium, where a portion of the target values report one of the third metrics and status indicators stored in a fifth region of the range of memory addresses in the medium with each status indicator reporting to one of the target values.

In the data structure, the first metric may include a scorecard, the second metrics may include objectives or higher level KPI's, and the third metrics may include KPI's.

The data structure may be used to determine a score for each of a selected portion of third metrics based on a comparison of actual values for each of the third metrics and associated target values. The data structure may also be used to determine a score for each of a selected portion of the second metrics based on a weighted aggregation of scores of the third metrics reporting to each of the selected portion of the second metrics. Moreover, the data structure may further be used to determine a score for the first metric based on score of selected second and third metrics.

Referring to FIG. 3, scorecard engine may also enable subscribers to reuse and customize scorecards by inheriting scorecard metrics. The reporting metrics may be provided to other applications 318 and used to create new scorecards, charts, analyses, and the like. A subscriber may also use the scorecard engine to perform those actions in a distributed system.

Data for evaluating various measures may be provided by a data source. The data source may include source systems 312, which provide data to a scorecard cube 314. Source systems 312 may include multi-dimensional databases such as an Online Analytical Processing (OLAP) database, other databases, individual files, and the like, that provide raw data for generation of scorecards. Scorecard cube 314 is a multi-dimensional database for storing data to be used in determining Key Performance Indicators (KPIs) as well as generated scorecards themselves. As discussed above, the multi-dimensional nature of scorecard cube 314 enables storage, use, and presentation of data over multiple dimensions such as compound performance indicators for different geographic areas, organizational groups, or even for different time intervals. Scorecard cube 314 has a bi-directional interaction with scorecard engine 308 providing and receiving raw data as well as generated scorecards.

Scorecard database 316 is arranged to operate in a similar manner to scorecard cube 314. In one embodiment, scorecard database 316 may be an external database providing redundant back-up database service.

Scorecard builder 302 may be a separate application, a part of the performance evaluation application, and the like. Scorecard builder 302 is employed to configure various parameters of scorecard engine 308 such as scorecard elements, default values for actuals, targets, and the like. Scorecard builder 302 may include a user interface such as a web service, a Graphical User Interface (GUI), and the like.

Strategy map builder 304 is employed for a later stage in scorecard generation process. As explained below, scores for KPIs and parent nodes such as Objective and Perspective may be presented to a user in form of a strategy map. Strategy map builder 304 may include a user interface for selecting graphical formats, indicator elements, and other graphical parameters of the presentation.

Data Sources 306 may be another source for providing raw data to scorecard engine 308. Data sources may be comprised of a mix of several multi-dimensional and relational databases or other Open Database Connectivity (ODBC)—accessible data source systems (e.g. Excel, text files, etc.). Data sources 306 may also define KPI mappings and other associated data.

Scorecard architecture 300 may include scorecard presentation 310. This may be an application to deploy scorecards, customize views, coordinate distribution of scorecard data, and process web-specific applications associated with the performance evaluation process. For example, scorecard presentation 310 may include a web-based printing system, an email distribution system, and the like. A user interface for scorecard presentation 310 may also include an overview of available scorecards for a subscriber to select from. Scorecard presentation 310 may further include a matrix or a list presentation of the scorecard data.

As described above, other scorecard applications 318 may include any application that receives data associated with a scorecard and consumes the data to provide a report, perform analysis, provide alerts, perform further calculations, and the like. The data associated with the reporting metrics may include content data and metadata (property information). Other scorecard applications may be selected based on the scorecard configuration, a subscriber request, or a user interface configuration. The user interface configuration may include a subscriber credential or a subscriber permission attribute. Other applications 318 may include a graphical representation application, a database application, a data analysis application, a communications application, an alerting application, or a word processing application.

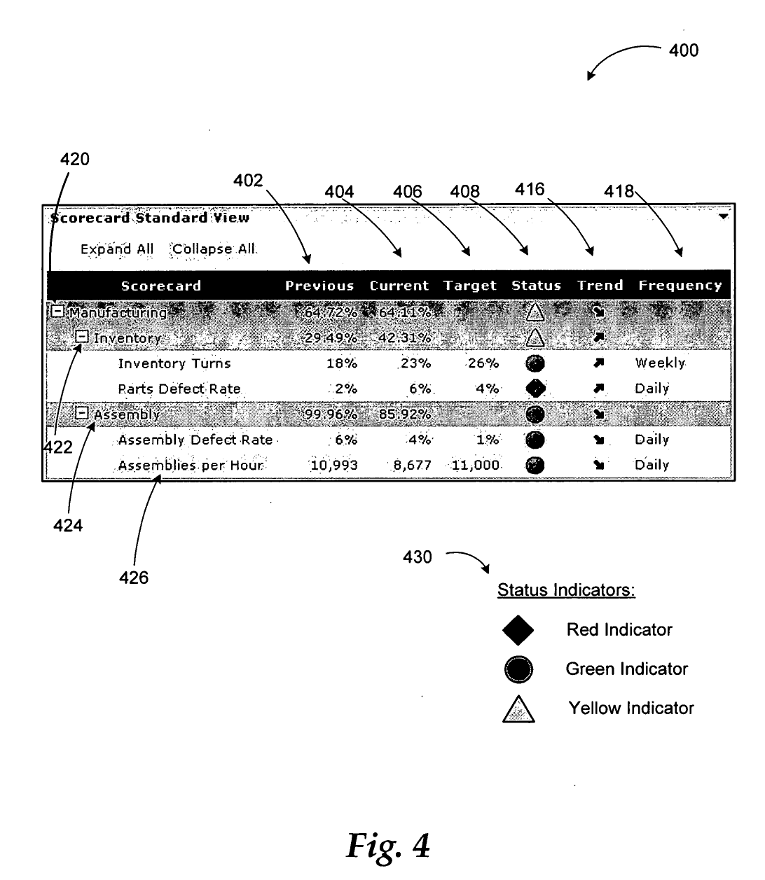

FIG. 4 illustrates a screenshot of an example scorecard. As explained before, Key Performance Indicators (KPIs) are specific indicators of organizational performance that measure a current state in relation to meeting the targeted objectives. Decision makers may utilize these indicators to manage the organization more effectively.

When creating a KPI, the KPI definition may be used across several scorecards. This is useful when different scorecard managers might have a shared KPI in common. The shared use of KPI definition may ensure a standard definition is used for that KPI. Despite the shared definition, each individual scorecard may utilize a different data source and data mappings for the actual KPI.

Each KPI may include a number of attributes. Some of these attributes include frequency of data, unit of measure, trend type, weight, and other attributes.

The frequency of data identifies how often the data is updated in the source database (cube). The frequency of data may include: Daily, Weekly, Monthly, Quarterly, and Annually.

The unit of measure provides an interpretation for the KPI. Some of the units of measure are: Integer, Decimal, Percent, Days, and Currency. These examples are not exhaustive, and other elements may be added without departing from the scope of the invention.

A trend type may be set according to whether an increasing trend is desirable or not. For example, increasing profit is a desirable trend, while increasing defect rates is not. The trend type may be used in determining the KPI status to display and in setting and interpreting the KPI banding boundary values. The trend arrows displayed in scorecard 400 indicate how the numbers are moving this period compared to last. If in this period the number is greater than last period, the trend is up regardless of the trend type. Possible trend types may include: Increasing Is Better, Decreasing Is Better, and On-Target Is Better.

Weight is a positive integer used to qualify the relative value of a KPI in relation to other KPIs. It is used to calculate the aggregated scorecard value. For example, if an Objective in a scorecard has two KPIs, the first KPI has a weight of 1, and the second has a weight of 3 the second KPI is essentially three times more important than the first, and this weighted relationship is part of the calculation when the KPIs' values are rolled up to derive the values of their parent Objective.

Other attributes may contain pointers to custom attributes that may be created for documentation purposes or used for various other aspects of the scorecard system such as creating different views in different graphical representations of the finished scorecard. Custom attributes may be created for any scorecard element and may be extended or customized by application developers or users for use in their own applications. They may be any of a number of types including text, numbers, percentages, dates, and hyperlinks.

One of the benefits of defining a scorecard is the ability to easily quantify and visualize performance in meeting organizational strategy. By providing a status at an overall scorecard level, and for each perspective, each objective or each KPI rollup, one may quickly identify where one might be off target. By utilizing the hierarchical scorecard definition along with KPI weightings, a status value is calculated at each level of the scorecard.

First column of scorecard 400 shows example elements perspective 420 “Manufacturing” with objectives 422 and 424 “Inventory” and “Assembly” (respectively) reporting to it. Second column 402 in scorecard 400 shows results for each measure from a previous measurement period. Third column 404 shows results for the same measures for the current measurement period. In one embodiment, the measurement period may include a month, a quarter, a tax year, a calendar year, and the like.

Fourth column 406 includes target values for specified KPIs on scorecard 400. Target values may be retrieved from a database, entered by a user, and the like. Column 408 of scorecard 400 shows status indicators.

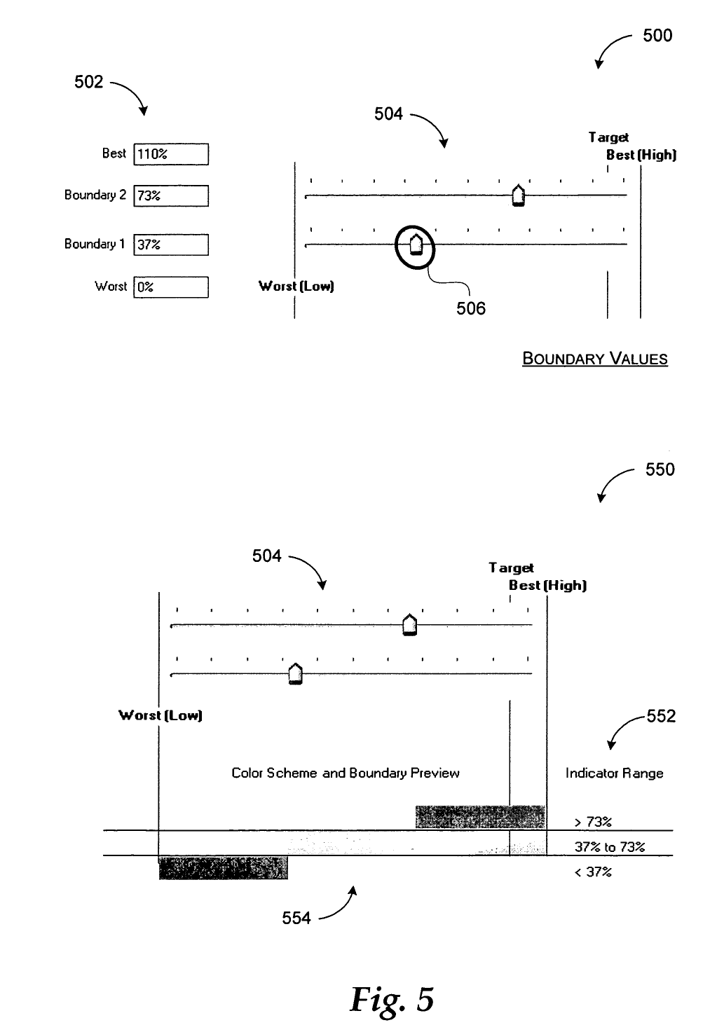

Status indicators 430 convey the state of the KPI. An indicator may have a predetermined number of levels. A traffic light is one of the most commonly used indicators. It represents a KPI with three-levels of results—Good, Neutral, and Bad. Traffic light indicators may be colored red, yellow, or green. In addition, each colored indicator may have its own unique shape. A KPI may have one stoplight indicator visible at any given time. Indicators with more than three levels may appear as a bar divided into sections, or bands as described below in conjunction with FIG. 5.

Column 416 includes trend type arrows as explained above under KPI attributes. Column 418 shows another KPI attribute, frequency.

FIG. 5 illustrates boundary selection in a scorecard application using text boxes and sliders, and relationship of boundary sliders with indicator ranges in boundary preview.

The user is provided with an option to use sliders to manipulate the boundary values or to manually enter them. In some embodiments, there may be more than one lower and upper boundary values (e.g. Closer To Target Is Better). The controls for entering Boundary Values are shown in user interface 500. When a user drags the slider (e.g. slider 506) in slider region 504 of the user interface, the values in the text boxes of text box region 502 are changed to reflect the current position of the slider. Conversely, when a boundary is manually entered into the text box the sliders are automatically adjusted to the correct position to reflect the change.

The number of sliders displayed is equal to the number of boundaries for the selected Indicator. In the case when there is more than one boundary value, the sliders restrict the user from overlapping boundaries. For example, if Boundary 1's slider is dragged to the right past Boundary 2's slider, Boundary 2's slider is automatically updated to be at the same position as Boundary 1's slider. This update is also reflected in the Boundary 2's text box. Following the same behavior of restricting overlapping with the sliders, if a boundary value is entered past another in the text box, the overlapped boundary value is changed.

The sliders and text boxes are not the only objects whose behavior is linked together. When the slider is moved, the changes are also reflected in the Boundary Preview and the Indicator Range regions as shown in user interface 550. The boundaries may be depicted by a change in color and level in Boundary Preview chart 554. As shown in user interface 550, the boundaries are depicted directly below slider region 504.

When a user drags a slider, the corresponding boundary is moved to reflect the change in slider position. The values under Indicator Range 552 are also updated to reflect the boundary changes and depict the correct values for the range. For example, in user interface 550 the lighter colored bar (indicating acceptable but potentially problem status) grows and the darker colored bar (indicating acceptable status) gets shorter, if the upper boundary is moved to the right to 80%. The 73% value in the Indicator Ranges is also changed to 80%.

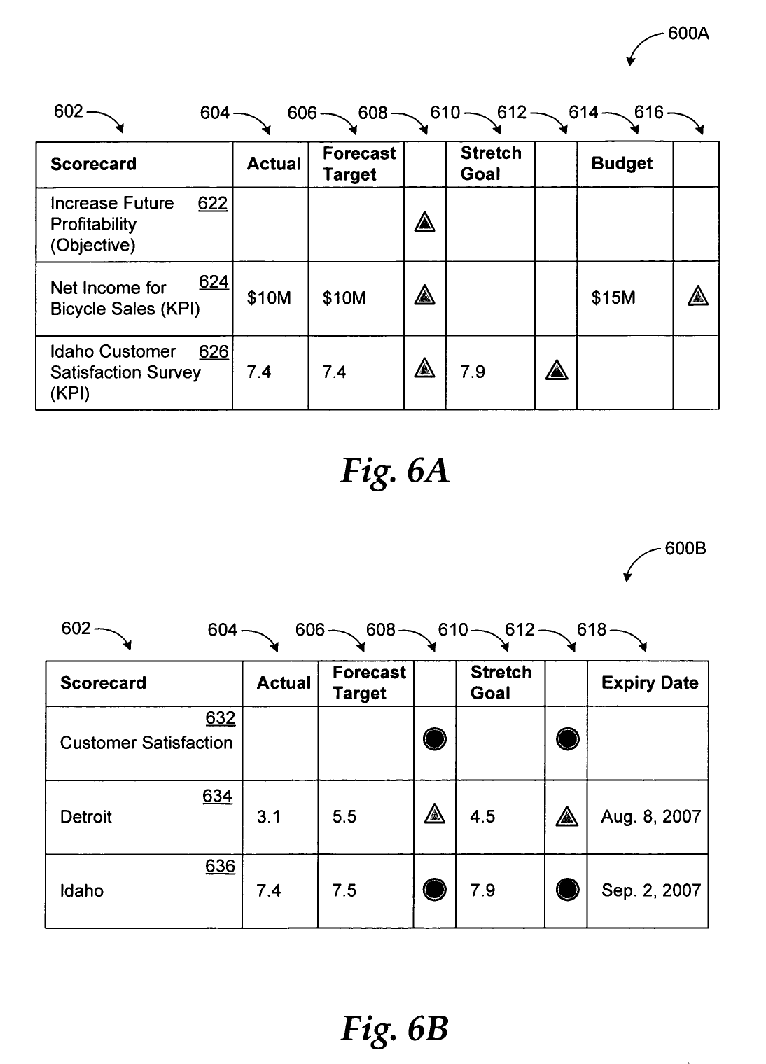

FIGS. 6A and 6B illustrate example scorecard structures where distinct and similar reporting metrics are rolled up in a scorecard.

Referring to FIG. 6A, scorecard 600A includes two different KPI's (624 and 626) reporting to one objective “Increase Future Profitability” (622). Each KPI has their own set of targets and actuals.

Net Income for Bicycles Sales 624 has two different targets: forecast target 606 based on an estimate of Net Income based on recent historical values and budget target 614, a value associated with a budgetary commitment made by the subsidiary to meet assigned on a quarterly basis.

Idaho Customer Satisfaction Survey 626 has a different schema with two targets: forecast target 606 representing the anticipated results of the survey and stretch goal target 610, a value for survey results that would represent extensive success.

Status indicators according to traffic light scheme are represented next to each target with a value in columns 608, 612, and 616. For objective 622, only one status indicator is shown in column 608 for forecast target 606, where both KPI's have values to be rolled up.

Scorecard 600A is an example of an instance where two distinct KPI's with different attributes are rolled up. As the scorecard shows, not all columns or rows have to be filled completely. The scorecard matrix may in some cases be sparse. However, by selecting reporting metrics, ordering the selected metrics, scoring based on the order while inheriting content and properties of the cells, a new scorecard may be created fitting a subscriber's custom needs.

Referring to FIG. 6B, scorecard 600B includes objective 632, “Customer Satisfaction” with its two reporting KPI's customer satisfaction for Detroit 634 and customer satisfaction for Idaho 636.

The similar KPI's have both forecast targets 606 and stretch goal targets 610 in addition to actuals 604. Both KPI's also have Expiry Date's 618 that indicate an expiration date for the KPI validity. Status indicators in columns 608 and 612 reflect results of a comparison between the actuals and respective target values. Status indicators for objective 632 are a result of rolling up the KPI scores.

With similar KPI's the scorecard matrix is not sparse. Elements of the scorecard such as targets, status indicators, individual KPI's, even the objectives may be selected for ordering and rescoring another scorecard.

While scorecard 600A and 600B are shown with limited elements, other implementations may include additional elements that can be selected for ordering and rescoring another scorecard.

Other scorecard presentations, target applications, status indicators, and the like may be implemented using the principles described herein.

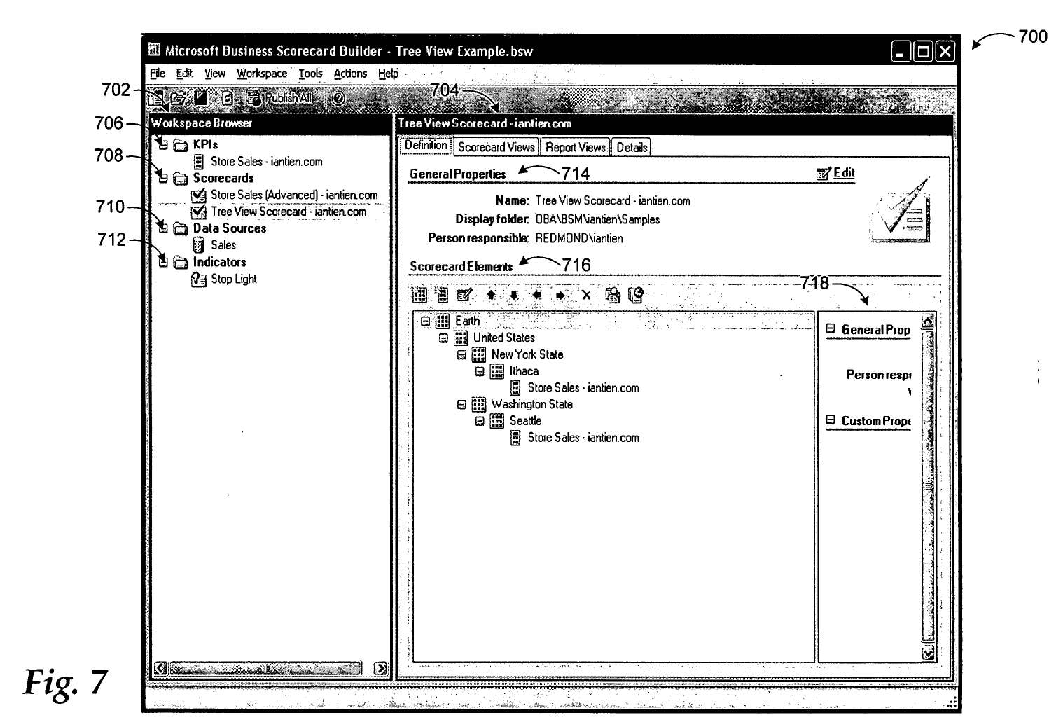

FIG. 7 illustrates a screenshot of an example scorecard application user interface 700. UI 700 includes, in addition to standard features such as a menu bar, workspace browser 702 and scorecard view 704.

Workspace browser 702 includes a listing of scorecards and scorecard elements available to a subscriber based on subscriber permissions, UI configuration, connection status, and the like. In the example UI 700, workspace 702 includes KPI's 706, scorecards 708, data sources 710, and indicators 712. KPI's 706 includes one example KPI, “Store Sales.” a tricolor icon next to the KPI name indicates that a traffic light scheme is used for status indicators of this KPI. Scorecards 708 include two example scorecards, “Store Sales” and “Tree View Scorecard.” “Tree View Scorecard” is highlighted indicating its selection and shown in detail in the scorecard view pane 704.

Data sources 710 lists one example data source, “Sales” database. Finally, indicators 712 include a listing of the available status indicator schemes. In the example UI 700, only one status indicator scheme is available, “Stop Light” scheme, also referred to as traffic light scheme, where red, green, and yellow indicator icons are used to summarize a comparison of a target value and an actual value.

Scorecard view pane 704 shows details of selected scorecard “Tree View Scorecard.” Details of the selected scorecard include general properties 714 (e.g. name, display folder, responsible person, etc.), scorecard elements 716, and property editing pane 718. Scorecard elements 716 graphically presents a hierarchy of objectives and KPI's within the selected scorecard. Status indicator scheme icons next to each element indicate the status indicator scheme used for the metric. A status indicator scheme for the new reporting metrics may be determined based on a first status indicator for reporting metrics or based on a majority of status indicators for the reporting metrics.

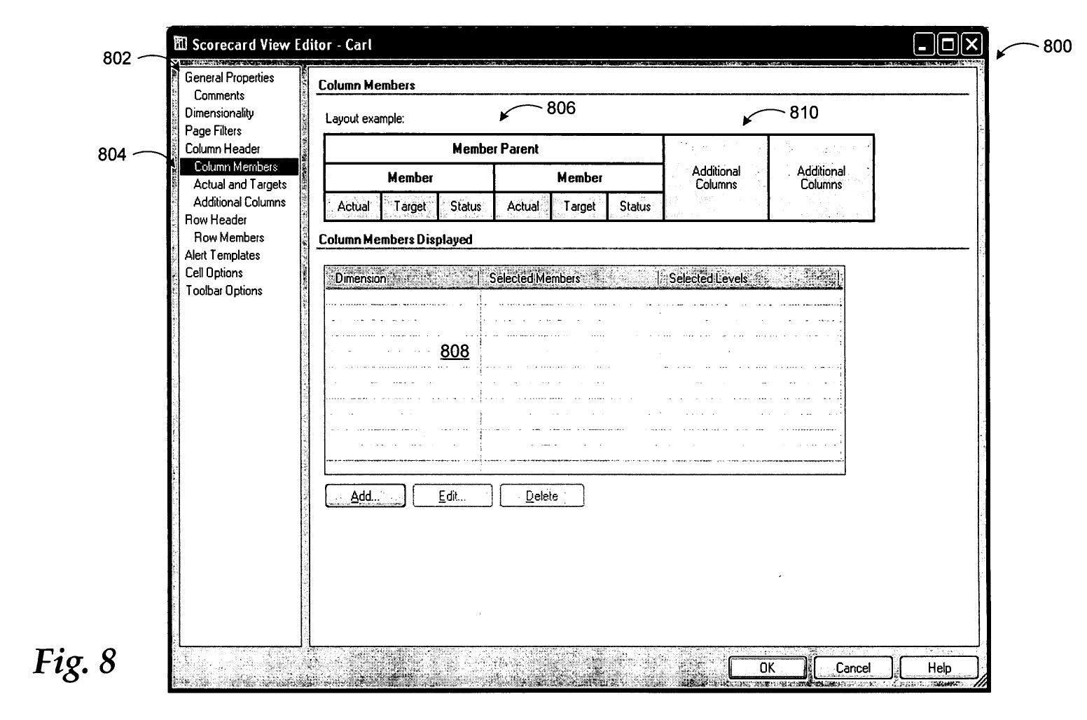

FIG. 8 illustrates a screenshot of user interface 800 for a scorecard view editor. UI 800 includes a listing of items that can be edited by a subscriber, such as general properties 802, dimensionality, page filters, and column header. General properties 802 enables the subscriber to modify values of general property items such as those described in conjunction with FIG. 7. Column header includes a number of sub-items such as column members 804.

As described previously, each reporting metric may have a plurality of targets assigned to it. Thus, for each reporting metric, there may be multiple columns. In one embodiment, three columns for each target (actual value, target value, and status indicator) may be shown in the scorecard presentation. In another embodiment, only the target value and status indicator may be shown for each target, and the actual value column may be shown once for the reporting metric. Detail view pane of UI 800 shows the details of selected item, “Column Members.” A structure of the column groups for each target and a parent-child relationship are shown in layout example 806. If any column members are selected, they are shown in the “column members displayed” pane 808 along with their dimension, and level. Additional columns may be inserted by the subscriber by clicking on additional columns 810.

Other editing methods may also be implemented using the principles described herein. Moreover, other elements of the scorecard, such as row slices, alert templates, and the like, may also be selected and edited using one of the methods described above.

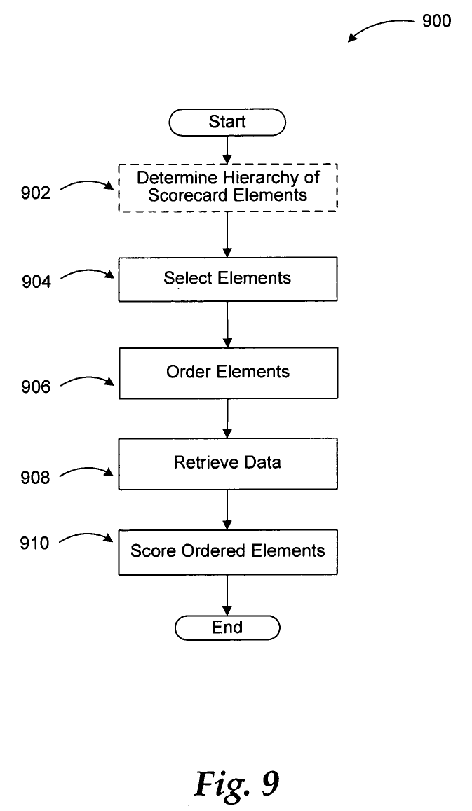

FIG. 9 illustrates a logic flow diagram of process 900 for repeated inheritance of heterogeneous business metrics.

According to one embodiment, a computer-implemented method for inheriting business reporting metrics includes selecting measures from reporting metrics, ordering the selected measures, and retrieving data associated with each selected measure. A new reporting metric is then dynamically scored based on the ordered measures. The method may further include determining a hierarchy of the reporting metrics. A page filter, a column header, a row header, and a roll-up may be used in scoring the new reporting metrics.

The measures may include a Key Performance Indicator (KPI), a KPI group, and an objective. Each KPI may be assigned targets and each target may be assigned a status indicator. A status indicator scheme for the new reporting metrics may be determined based on a first status indicator for the reporting metrics or based on a majority of status indicators for the reporting metrics.

Process 900 begins at optional operation 902, where a hierarchy of scorecard elements is determined. As explained before, elements such as KPI's, KPI groups, and objectives exist in a scorecard with a particular roll-up relationship or hierarchy. The hierarchy of these reporting metrics determines how the scores are to be calculated based on weighted aggregations (roll-ups). Processing advances from optional operation 902 to operation 904.

At operation 904, elements of the scorecard are selected. Elements selected for reordering and recalculation may include KPI's, KPI groups, objectives, targets, indicators, and data sources. A number of reporting metrics may be selected at the same time by row slices, or a number of targets may be selected at the same time by column slices. Processing moves from operation 904 to operation 906.

At operation 906, the elements are ordered. Ordering involves determining roll-up relationships between the reporting metrics of the new scorecard based on the hierarchy of the selected elements in the previous scorecard. Processing advances to operation 908 from operation 906.

At operation 908, data associated with the ordered metrics is retrieved. The data associated with each selected metric may include content and property information associated with the selected measures, where the property information designates the content as one of: a number, a string, and a graphic symbol. In another embodiment, the property information may be modified in response to a subscriber input.

Furthermore, source data for at least one measure may be modified in response to a subscriber input when scoring the new reporting metrics. A column header, a row header, and a roll-up may also be modified in response to a subscriber input when ordering the selected measures. Processing moves from operation 908 to operation 910.

At operation 910, the metrics of the new scorecard are scored based on their order and associated data. Scores may be presented in numeric form or graphically using a status indicator scheme. A status indicator scheme for the new reporting metrics may be determined based on a first status indicator for the reporting metrics or based on a majority of status indicators for the reporting metrics. After scoring the new scorecard at operation 910, processing moves to a calling process for further actions.

The operations included in process 900 are for illustration purposes. Repeatedly inheriting reporting metrics in a business logic system may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for inheriting business reporting metrics, comprising:
selecting measures from reporting metrics;
ordering the selected measures;
retrieving data associated with each selected measure; and
dynamically scoring a new reporting metrics based on the ordered measures.

2. The computer-implemented method of claim 1, further comprising determining a hierarchy of the reporting metrics.

3. The computer-implemented method of claim 1, wherein the data associated with each selected measure includes at least one of: content and property information associated with the selected measures.

4. The computer-implemented method of claim 3, wherein the property information designates the content as one of: a number, a string, and a graphic symbol.

5. The computer-implemented method of claim 3, further comprising modifying the property information in response to a subscriber input.

6. The computer-implemented method of claim 1, further comprising determining a status indicator scheme for the new reporting metrics based on a first status indicator for the reporting metrics.

7. The computer-implemented method of claim 1, further comprising determining a status indicator scheme for the new reporting metrics based on a majority of status indicators for the reporting metrics.

8. The computer-implemented method of claim 1, wherein at least one of a page filter, a column header, a row header, and a roll-up is used in scoring the new reporting metrics.

9. The computer-implemented method of claim 1, further comprising modifying source data for at least one measure in response to a subscriber input when scoring the new reporting metrics.

10. The computer-implemented method of claim 1, further comprising modifying at least one of a column header, a row header, and a roll-up in response to a subscriber input when ordering the selected measures.

11. The computer-implemented method of claim 1, wherein the measures includes at least one of: a Key Performance Indicator (KPI), a KPI group, and an objective.

12. The computer-implemented method of claim 1, further comprising providing the new reporting metrics to at least one of: an electronic mail application, an alerting application, a presentation application, and an analysis application.

13. A computer-readable medium having stored thereon a data structure for inheriting reporting metrics in a business logic system, the data structure comprising:
a first metric stored in a first region of a range of memory addresses in the medium;
second metrics stored in a second region of the range of memory addresses in the medium, wherein a portion of the second metrics report to the first metric based on a predetermined roll-up relationship; and
third metrics stored in a third region of the range of memory addresses in the medium, wherein a first portion of the third metrics report to one of the second metrics based on the predetermined roll-up relationship, and wherein a second portion of the third metrics report to the first metric based on the predetermined roll-up relationship.

14. The computer-readable medium of claim 13, the data structure further comprising:
target values stored in a fourth region of the range of memory addresses in the medium, wherein a portion of the target values report one of the third metrics; and
status indicators stored in a fifth region of the range of memory addresses in the medium, wherein each status indicator reports to one of the target values.

15. The computer-readable medium of claim 14, wherein the first metric includes a scorecard, the second metrics includes objectives, and the third metrics includes KPI's.

16. The computer-readable medium of claim 14, wherein the data structure is used to determine a score for each of a selected portion of the third metrics based on a comparison of actual values for each of the third metrics and associated target values.

17. The computer-readable medium of claim 16, wherein the data structure is used to determine a score for each of a selected portion of the second metrics based on a weighted aggregation of scores of the third metrics reporting to each of the selected portion of the second metrics.

18. The computer-readable medium of claim 17, wherein the data structure is used to determine a score for the first metric based on score of selected second and third metrics.

19. A system for inheriting business reporting metrics, the system comprising:
a score-calculation engine configured to:
select measures from reporting metrics;
order the selected measures;
retrieve data associated with each selected measure; and
dynamically score a new reporting metrics based on the ordered measures; and
a user interface configured to:
present available reporting metrics and measures for selection; and
display a scorecard presentation for the new reporting metrics.

20. The system of claim 19, further comprising a database configured to store content data and property information associated with the reporting metrics, the measures, and a roll-up relationship associated with each of the reporting metrics.
